(19) United States
(12) Patent Application Publication
(10) Pub. No.: US 2011/0202248 A1
(43) Pub. Date: Aug. 18, 2011

(54) METHOD AND CONTROL/REGULATION SYSTEM FOR BRAKING A VEHICLE, AND VEHICLE

(75) Inventors: Andreas Klausner, Graz (AT); Helfried Müller, Weinzettl (AT); Gerald Teuschl, Graz (AT); Wolfgang Vorraber, Pirka (AT)

(73) Assignee: MAGNA STEYR Fahrzeugtechnik AG & Co., KG, Graz (AT)

(21) Appl. No.: 13/028,342

(22) Filed: Feb. 16, 2011

Related U.S. Application Data
(60) Provisional application No. 61/304,883, filed on Feb. 16, 2010.

(30) Foreign Application Priority Data
Jul. 10, 2010 (DE) 10 2010 027 348.1

(51) Int. Cl. B60T 8/17; G06F 19/00; B60T 1/10; B60T 7/12; B60T 8/171

(52) U.S. Cl. 701/70

(57) ABSTRACT

A method and a control/regulation system for braking a vehicle having a regenerative braking system and a nonregenerative braking system, and a vehicle employing the same. The method includes detecting a position and/or a motion of an accelerator pedal and then determining whether the detected position and/or motion corresponds to a specifiable position or to a specifiable motion which is associated with a deceleration request. The regenerative braking system is correspondingly activated when the result of the check is positive. The nonregenerative braking system is additionally activated for a deceleration request which exceeds a braking capability of the regenerative braking system.

### CROSS-REFERENCE TO RELATED APPLICATIONS

The present application claims priority under 35 U.S.C. §119 to German Patent Application No. 10 2010 027 348.1 (filed on Jul. 10, 2010) and U.S. Provisional Patent Application No. 61/304,883 (filed on Feb. 16, 2010), which are each hereby incorporated by reference in their respective entireties.

### FIELD OF THE INVENTION

The invention relates to a method for braking a vehicle having a regenerative braking system and a nonregenerative braking system. In a first step a position and/or a motion of an accelerator pedal is detected. A check is then made whether the detected position and/or motion correspond(s) to a specifiable position or to a specifiable motion which is associated with a deceleration request. Lastly, the regenerative braking system is activated when the result of the check is positive.

The invention further relates to a control/regulation system for a vehicle having a regenerative braking system and a nonregenerative braking system. The control/regulation system includes an input for detecting a position and/or a motion of an accelerator pedal, means for checking whether the detected position and/or motion correspond(s) to a specifiable position or to a specifiable motion which is associated with a deceleration request, and an output for activating the regenerative braking system and an output for activating the nonregenerative braking system.

Lastly, the invention relates to a vehicle, including an accelerator pedal, a regenerative braking system, and a nonregenerative braking system, in which a control/regulation system for braking the vehicle is connected to the accelerator pedal, [the regenerative braking system, and] the nonregenerative braking system.

### BACKGROUND OF THE INVENTION

For quite some time, efforts have been undertaken to prevent the energy necessary for braking a vehicle from being converted into heat, and thus, more or less irretrievably destroyed. Instead, efforts have been made to store the kinetic energy withdrawn from the vehicle in an energy storage system and to supply it back to the vehicle when needed. Such systems are referred to as “regenerative” or “recuperative” braking systems. In contrast to such systems are nonregenerative braking systems, which generally convert the kinetic energy into heat. Regenerative braking is currently used particularly successfully in electric drives. In principle, of course, regenerative braking may also be used for other types of drives.

In addition, environmental and economic considerations have resulted in a continually increasing number of electric motor vehicles for private transport. To assist the users of these motor vehicles in changing to an electric motor vehicle from a vehicle which is driven by an internal combustion engine, attempts have been made, among other things, to imitate the dynamic behavior of an internal combustion engine in the control of an electric motor. Imitated in particular, among other things, is the deceleration effect of an internal combustion engine when the gas or accelerator pedal is let up or released. As a result, an electric vehicle is also actively braked when the gas or accelerator pedal is let up or released, and does not continue to merely travel forward.

A system for an electric drive vehicle is disclosed in U.S. Pat. No. 6,513,882, for example, in which releasing the accelerator pedal as well as activating the brake pedal results in active braking of the vehicle. The deceleration behavior of an internal combustion engine upon release of the accelerator pedal is thus simulated by the unobtrusive activation of a friction brake.

In this regard it is problematic that, although an electric drive vehicle is very well suited for the use of a regenerative braking system, as mentioned above, the vehicle is decelerated by the friction brake when the accelerator pedal is released. Behavior of an internal combustion engine is in fact simulated, but in an unfavorable manner in terms of energy.

Furthermore, U.S. Pat. No. 5,433,512 discloses a system in which, upon activation of the brake pedal, an attempt is made to handle the braking request using a regenerative braking system if possible. If this is not possible, a friction brake is additionally activated.

A problem in this regard is that the position or motion of the accelerator pedal is evaluated only for regulating the power supply to the engine. In contrast, braking is performed by activating the brake pedal. It is readily apparent that the behavior of an internal combustion engine may be imitated only to a limited extent, in which the release of the accelerator pedal does in fact result in a noticeable deceleration of the vehicle.

### SUMMARY OF THE INVENTION

In accordance with embodiments of the present invention, it is an object, therefore, to provide an enhanced method and an enhanced control/regulation system for braking a vehicle, and to provide an enhanced vehicle employing such a braking system. It is an aim in particular to economically implement the imitation of the driving characteristics of a vehicle driven by an internal combustion engine.

In accordance with embodiments of the present invention, such an object can be achieved by a method of the type stated at the outset, in which the nonregenerative braking system is additionally activated for a deceleration request of the accelerator pedal which exceeds the braking capability of the regenerative braking system.

In accordance with embodiments of the present invention, such an object can also be achieved by a control/regulation system of the type stated at the outset, which is designed to activate both the nonregenerative braking system and the regenerative braking system for a deceleration request of the accelerator pedal which exceeds a braking capability of the regenerative braking system.

In accordance with embodiments of the present invention, such an object can also be achieved by a vehicle which includes an accelerator pedal, a regenerative braking system, and a nonregenerative braking system, whereby a control/regulation system for braking the vehicle is operatively connected to the accelerator pedal, the regenerative braking system, and the nonregenerative braking system.

In accordance with embodiments of the present invention, letting up or otherwise releasing the accelerator pedal on the one hand results in an active deceleration of the vehicle, but makes use of a regenerative braking system in an efficient, economical manner. In addition, the users of vehicles manufactured in accordance with embodiments may gradually become accustomed to a new generation of vehicles which in principle have only one pedal, namely, an accelerator pedal, which may also be used to decelerate the vehicle. Embodiments of the present invention, therefore, follow a different approach than U.S. Pat. No. 5,433,512, which assumes that in the future a brake pedal will necessarily be installed in the vehicles. Naturally, however, the use of a brake pedal is also possible in accordance with embodiments of the present invention.

Embodiments of the present invention are particularly suited for electric motor vehicles, although the kinetic energy may also be stored in another manner. For example, a regenerative braking system may be implemented using a compressor or turbine which supplies and withdraws energy to/from a compressed air storage system. In addition, the energy recovered upon deceleration of the vehicle could be mechanically stored, etc.

Embodiments of the present invention are also suitable in principle for passenger motor vehicles and trucks. Furthermore, use and practice of embodiments of the present invention for rail vehicles is also conceivable, in particular, for streetcars and subway cars which change speed very frequently and rapidly.

At this point, it is noted that the term “control/regulation system” is understood here to mean devices for carrying out the method in accordance with embodiments of the present invention, which may include elements of a control system and/or a regulation system. The control/regulation system in accordance with embodiments of the present invention, may in particular be part of a driving controller for an electric vehicle.

Advantageous embodiments and refinements of the present invention result from the subclaims, and from the description in conjunction with the figures of the drawing.

In accordance with embodiments of the present invention, it is particularly advantageous when the nonregenerative braking system is activated only enough to cover the portion of the deceleration request which exceeds the braking capability of the regenerative braking system. Optimal use of the regenerative braking system may be made in this way. The vehicle may, therefore, be decelerated in a particularly efficient manner.

In accordance with embodiments of the present invention, it is also advantageous when, in addition to detection of a position and/or a motion of an accelerator pedal, a position and/or a motion of a brake pedal is detected, and with regard to the division of the deceleration request between the regenerative braking system and the nonregenerative braking system, a deceleration request of the brake pedal is treated analogously to a deceleration request of the accelerator pedal. In this variant of embodiments of the invention, a brake pedal is provided in addition to the accelerator pedal. A deceleration request which is made in a known manner by depressing the brake pedal (and not by releasing, as is the case for the accelerator pedal) is treated in the same or similar manner as for a deceleration request of the accelerator pedal; i.e., regenerative braking is performed to the extent possible, and only then is the nonregenerative brake activated.

In accordance with embodiments of the present invention, it is further advantageous when, in addition to detection of a position and/or a motion of an accelerator pedal, a position and/or a motion of a brake pedal is detected, and the maximum achievable deceleration using the brake pedal is greater than the maximum achievable deceleration using the accelerator pedal. This variant of embodiments of the invention may be easier for current automobile drivers to use, since the brake pedal, the same as for conventional vehicles, is able to bring about more intense deceleration than from releasing the accelerator pedal. The latter results in only moderate deceleration for vehicles having an internal combustion engine.

In accordance with embodiments of the present invention, yet another advantage is that a deceleration request, even for existing vehicles, is made much more frequently by letting up on the accelerator pedal than by activating the brake pedal; i.e., for every deceleration request braking is not performed using the brake pedal. Because the maximum achievable deceleration using the accelerator pedal is less than the maximum achievable deceleration using the brake pedal, the (relative) portion of regenerative braking for the accelerator pedal is greater than for the brake pedal. Since braking requests are more frequent via the accelerator pedal, as previously mentioned herein, the likelihood that a braking request may be met via the regenerative braking system may be comparatively high. This likelihood may be further increased when the maximum achievable deceleration using the accelerator pedal is set in such a way that it does not exceed the braking capability of the regenerative braking system. In contrast, the maximum achievable deceleration using the brake pedal is set to the braking capability of the nonregenerative braking system, which as a rule is much greater than the braking capability of the regenerative braking system.

If storage batteries (lithium ion cells, for example) are present in the regenerative braking system, the method in accordance with embodiments of the present invention may advantageously be adjusted in such a way that regenerative braking is allowed when the state of charge (SOC) of the storage battery is in a range between 5% and 95%.

In accordance with embodiments of the present invention, it is additionally advantageous when the maximum achievable deceleration using the accelerator pedal and/or the maximum achievable deceleration using the brake pedal is/are a function of the speed of the vehicle. In this way, the vehicle may be prevented from abruptly coming to a stop at low speeds. The braking power required at high speeds is many times greater than that at lower speeds.

In accordance with embodiments of the present invention, it is also advantageous when the level of the deceleration request is a function of the speed with which the accelerator pedal or the brake pedal is moved. In this variant it is not only the pedal position, but alternatively or additionally, the pedal motion which is evaluated. For example, a slow release of the accelerator pedal may be interpreted as a moderate deceleration request, whereas the sudden release of the accelerator pedal is interpreted as a request for maximum deceleration, i.e., full braking.

In accordance with embodiments of the present invention, in another advantageous variant, the maximum achievable deceleration using the accelerator pedal and/or the maximum achievable deceleration using the brake pedal may be individually set. The driving characteristics of the vehicle may, therefore, be optimally adjusted to the driver. This function may also be satisfactorily used to gradually accustom drivers to vehicles having only an accelerator pedal. For this purpose, the maximum achievable deceleration using the brake pedal/accelerator pedal is decreased/increased over time until the brake pedal practically has no function. To this end, the driver may be prompted at regular intervals by an onboard computer to make the adjustments as defined hereinabove. Of course, this adaptation may also be carried out automatically. It may be provided in particular that a given setting and also adaptation is associated with a given vehicle code, and is stored and individually retrieved similarly as for settings for the seats or outside mirrors. The action of the pedals may, therefore, be automatically adapted to the person who is operating the vehicle at that moment.

In this regard it is particularly advantageous when various dependencies of the maximum achievable deceleration using the accelerator pedal and/or of the maximum achievable deceleration using the brake pedal as a function of the speed of the vehicle may be individually set. This represents a refinement of the previously described individual setting of the pedals. In this variant, various profiles may be selected for the pedals. Thus, for a leisurely and/or conservative driver a setting may be meaningful which reduces the maximum achievable deceleration at low speeds, whereas for a sporty driver a profile is preferred in which there is little or no reduction in the maximum achievable deceleration at low speeds.

In accordance with embodiments of the present invention, it is also advantageous when, in addition to detection of a position and/or a motion of an accelerator pedal, a position and/or a motion of a brake pedal is detected, and for a deceleration request of the brake pedal only the nonregenerative braking system is activated. In this variant of embodiments of the invention, a brake pedal is likewise present, but, the same as for a vehicle having an internal combustion engine, the brake pedal results only in an activation of a nonregenerative braking system. In this manner, the behavior of a vehicle operated with an internal combustion engine may be better imitated.

In accordance with embodiments of the present invention, it is particularly advantageous when an electric storage battery is provided as the energy storage system for the regenerative braking system, and a state of charge and/or a temperature of the electric storage battery is/are used for determining the braking capability of the regenerative braking system. As mentioned herein, a storage battery is very well suited for a regenerative braking system, although certain operating states of the storage battery may also result in limitation of the braking capability of the regenerative braking system. For example, a fully charged storage battery is unable to receive more energy, so that there is little or no possibility for regenerative braking, depending on the state of charge.

Furthermore, a high temperature of the storage battery may result in limited braking capability, since an occasional very rapid transfer of energy could result in an exceedance of an allowed temperature of the storage battery. For these reasons, in this variant of embodiments of the invention, the state of charge and/or the temperature of the storage battery is/are ascertained and used in determining the braking capability of the regenerative braking system. A fully charged storage battery and/or an excessively high or also excessively low operating temperature may result in only the nonregenerative braking system being activated for a deceleration request.

In accordance with embodiments of the present invention, it is advantageous when the maximum deceleration achieved using the accelerator pedal is at least 4 m/s². A noticeably perceivable deceleration of the vehicle using the accelerator pedal (and not just using a brake pedal) may, therefroe, be achieved.

In accordance with embodiments of the present invention, it is particularly advantageous when the braking capability of the regenerative braking system is optically and/or acoustically displayed. To assist the driver in attaining an energy-efficient driving style, the braking capability of the regenerative braking system is optically and/or acoustically displayed. For example, the level of the deceleration request may be compared to the braking capability of the regenerative braking system, for example, using bars, indicators or other indicia on the instrument panel.

Lastly, in accordance with embodiments of the present invention, it is particularly advantageous when the activation of the nonregenerative braking system is optically and/or acoustically displayed. To assist the driver in attaining an energy-efficient driving style, the activation of the nonregenerative braking system is optically and/or acoustically displayed. For this purpose, for example, a display light on the instrument panel is possible which lights up when the nonregenerative braking system is active. These measures assist the driver in driving in an anticipatory manner so that he performs only regenerative braking when possible.

At this point it is noted that the alternatives stated for the method in accordance with embodiments of the present invention, and the resulting advantages may likewise relate to the control/regulation system and vehicle in accordance with embodiments of the present invention, and vice versa.

It is further noted that the method in accordance with embodiments of the present invention may be implemented in software and/or hardware. For example, the control/regulation may be performed by a program which runs in a processor. However, the control/regulation system may also be implemented by a hard-wired logic system. Of course, mixed forms are also conceivable.

The above embodiments and refinements of the invention may be combined in any desired manner.

### BRIEF DESCRIPTION OF THE DRAWINGS

Embodiments of the present invention is explained in greater detail below based on the exemplary embodiments described with reference to the schematic figures of the drawing, which show the following:

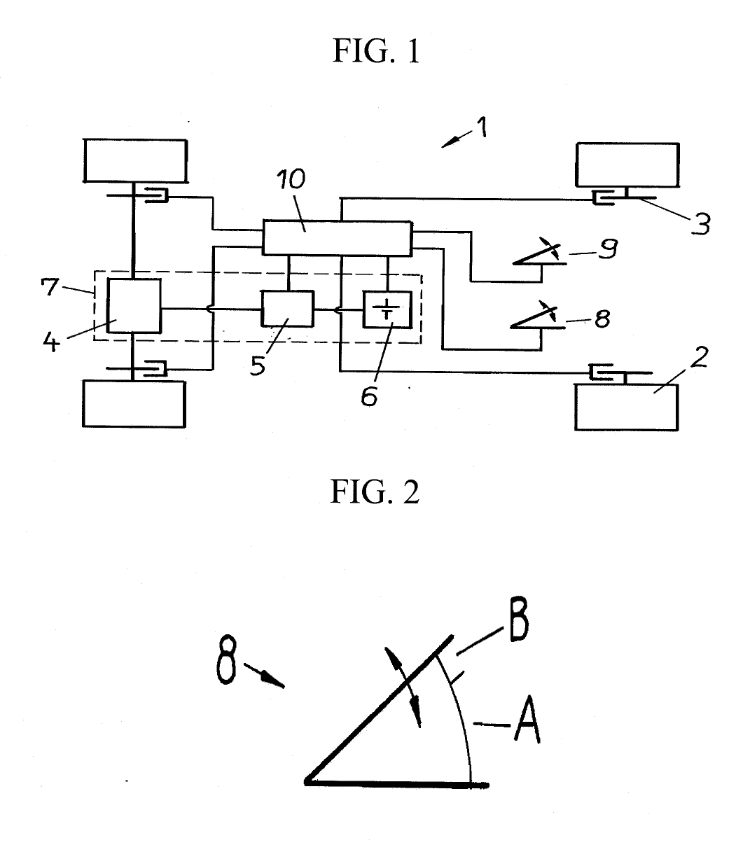

Example FIG. 1 illustrates an example of a schematically illustrated vehicle, in accordance with embodiments of the present invention.

Example FIG. 2 illustrates a detailed view of an accelerator pedal, in accordance with embodiments of the present invention.

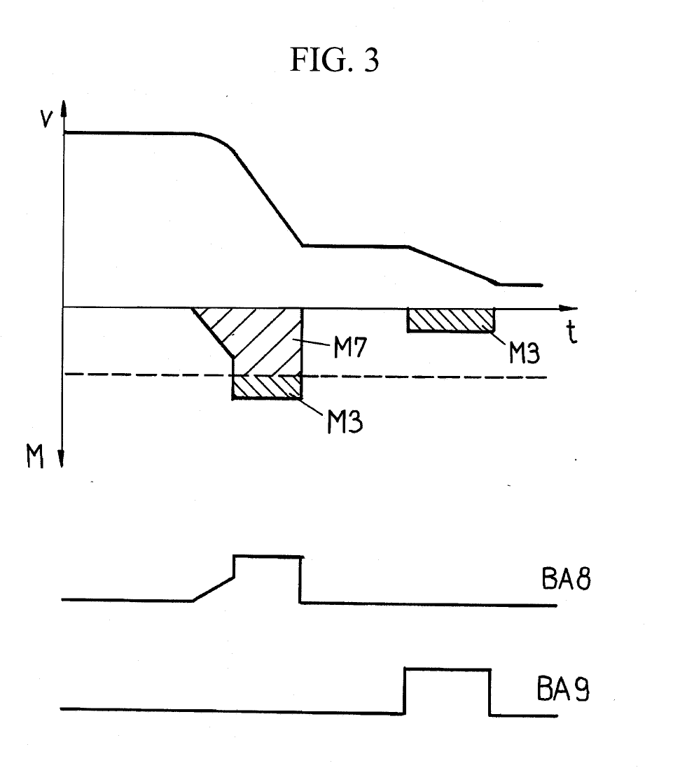

Example FIG. 3 illustrates an example of a variation of the vehicle speed and the braking torque as a function of time, in accordance with embodiments of the present invention.

### DETAILED DESCRIPTION OF EMBODIMENTS

Example FIG. 1 shows an example of a schematically illustrated vehicle 1 in accordance with embodiments of the present invention. Vehicle 1 includes four wheels 2 each having friction brakes 3, and electric motor 4 for the drive of vehicle 1. Electric motor 4 is operatively connected to driving controller 5, which in turn is operatively connected to storage battery 6. Electric motor 4, driving controller 5, and storage battery 6 form regenerative braking system 7, and friction brakes 3 form the nonregenerative braking system. Vehicle 1 also includes accelerator pedal 8 and brake pedal 9. Lastly, vehicle 1 includes control/regulation system 10 which is operatively connected to regenerative braking system 7, in particular to driving controller 5 and storage battery 6. Nonregenerative braking system 3 is operatively connected to accelerator pedal 8 and brake pedal 9.

In accordance with embodiments of the present invention, vehicle 1 illustrated in example FIG. 1 functions as follows. Control/regulation system 10 receives via accelerator pedal 8, in a manner known per se, a request for a setpoint speed of vehicle 1 or a setpoint power output, i.e., a setpoint rotational speed or a setpoint torque output of electric motor 4. The farther down the accelerator pedal is depressed, the more intensely vehicle 1 is accelerated, and thus, the faster it travels. When accelerator pedal 8 is released, vehicle 1 is decelerated, i.e., travels more slowly.

Control/regulation system 10 checks or determines whether the detected position and/or motion of accelerator pedal 8 corresponds to a specifiable position or to a specifiable motion which is associated with a deceleration request. For example, it may be provided that a reverse motion of accelerator pedal 8, i.e., letting up on accelerator pedal 8, is regarded as a deceleration request by the driver of vehicle 1. Alternatively or additionally, it may be provided that the motion of accelerator pedal 8 in the vicinity of the neutral range is regarded as a deceleration request.

As illustrated in example FIG. 2, this is illustrated once more in a detailed view of accelerator pedal 8. For example, a reverse motion, regardless of the position of accelerator pedal 8, may be regarded as a deceleration request. In another variant, the position of accelerator pedal 8 is evaluated. For example, a motion of accelerator pedal 8 in range A may be regarded as an acceleration request, and a motion in range B may be regarded as a deceleration request. Of course, the two variants may also be combined. In particular, the level of the desired deceleration is determined based on the position of accelerator pedal 8 and/or based on the speed of the release of accelerator pedal 8. For example, a slow release of accelerator pedal 8 may be interpreted as a moderate deceleration request, whereas the sudden release of accelerator pedal 8 may be interpreted as a request for maximum deceleration. In addition, the maximum achievable deceleration using accelerator pedal 8 may be a function of the speed of vehicle 1, for example, to prevent vehicle 1 from coming to an abrupt stop at low speeds during a braking request.

In another advantageous variant of embodiments of the invention, the maximum achievable deceleration using accelerator pedal 8 may be individually set. This means that a motion of accelerator pedal 8 in range B, i.e., the release of accelerator pedal 8, with a given speed results in a request for lesser or greater deceleration, depending on the setting. It would also be possible to provide progressive and degressive characteristic curves for selection in addition to a linear characteristic curve of accelerator pedal 8. For these characteristic curves, a given relationship (which is not necessarily linear) between the position/speed of accelerator pedal 8 and the desired deceleration is defined. (Note: the speed of accelerator pedal 8 is not the speed requested using the accelerator pedal, but, rather, is the motion of accelerator pedal 8 per se.) In another advantageous variant of embodiments of the invention, alternatively or additionally, various dependencies of the maximum achievable deceleration using accelerator pedal 8 as a function of the speed of vehicle 1 may be individually set.

Regenerative braking system 7 is activated when a deceleration request is determined. In the specific case, driving controller 5 is actuated in such a way that engine or motor 4 is operated as a generator, and thus, withdraws kinetic energy from vehicle 1, which is transferred to storage battery 6. If the braking capability of regenerative braking system 7 is not sufficient to meet the deceleration request, for example, because engine 4, driving controller 5, or storage battery 6 is inadequately dimensioned with regard to power, nonregenerative braking system, i.e., friction brakes 3, is additionally activated. Another reason that the deceleration request cannot be met may be that storage battery 6 is fully charged and is unable to receive more energy. In addition, an excessively high or excessively low temperature of storage battery 6 may result in inability to receive the electrical energy quickly enough.

To determine whether the deceleration request may be met, control/regulation system 10 has data concerning vehicle mass and vehicle speed, power of engine 4, and power of driving controller 5, for example, and data concerning storage battery 6, for example, the allowable charging current. In accordance with embodiments of the present invention, in one preferred variant the state of charge and/or the temperature of storage battery 6 is/are also determined. Based on all these data, control/regulation system 10 is then able to determine whether the braking capability of regenerative braking system 7 is sufficient to meet the deceleration request. If the braking capability is not sufficient, the nonregenerative braking system, i.e., brakes 3, is additionally activated. The nonregenerative braking system is advantageously activated only enough to cover the portion of the deceleration request by the driver which exceeds the braking capability of regenerative braking system 7. That is, regenerative braking system 7 is activated with full braking power, and the nonregenerative braking system is activated only enough to meet the deceleration request.

To assist the driver in attaining an energy-efficient driving style, the braking capability of regenerative braking system 7 is optically and/or acoustically displayed. For example, the level of the deceleration request may be compared to the braking capability of regenerative braking system 7, for example, using bars, indicators or other indicia. Alternatively or additionally, the activation of the nonregenerative braking system may be optically and/or acoustically displayed. For this purpose, for example a display light on the instrument panel is possible which lights up when nonregenerative braking system 3 is active. These measures assist the driver in driving in an anticipatory manner so that he performs only regenerative braking when possible.

Similarly as for the position and/or a motion of accelerator pedal 8, a position and/or a motion of brake pedal 9 may be evaluated in order to detect a deceleration request. Of course, depression of brake pedal 9, and not release, as is the case for accelerator pedal 8, is interpreted here as a deceleration request. This request may be met as described above, i.e., by making use of regenerative braking system 7 and activating the nonregenerative braking system as needed. However, it would also be conceivable that depressing brake pedal 9 results only in the activation of the nonregenerative braking system, i.e., an activation of friction brake 3. The maximum achievable deceleration using the brake pedal 9 is advantageously higher than the maximum achievable deceleration using accelerator pedal 8.

Example FIG. 3 shows an example of the variation of vehicle speed v and braking torque M as a function of time t. Illustrated below that diagram is a variation of a braking request BA8 of accelerator pedal 8 and a variation of a braking request BA9 of brake pedal 9 over time t. It is assumed that speed v is constant; the driver of vehicle 1 lets up on accelerator pedal 8. Initially, accelerator pedal 8 is continuously eased up (interpreted as a request for moderate deceleration), then is taken back in reverse (interpreted as a request for maximum deceleration). Based on this motion pattern, a deceleration request as illustrated in example FIG. 3 results, which is converted to braking torque M as illustrated. Corresponding to the curve of braking torque M, speed v of vehicle 1 changes, initially somewhat slowly, then relatively quickly. This is a very simple conversion of the position/motion of accelerator pedal 8 to braking torque M. Of course, this conversion may also be carried out in some other way.

The braking capability of regenerative braking system 7 is illustrated in the diagram as a dashed line. In the present example, this braking capability is assumed to be constant over time t and is therefore illustrated as a straight line. Of course, this is not an absolute requirement, and another progression of the braking capability is naturally possible.

It is apparent that the braking capability is initially sufficient to meet the deceleration request. However, after a point this is no longer sufficient, which is the reason that the nonregenerative braking system is additionally activated. The portion of regenerative braking system 7 is denoted by M7 in the diagram, and the portion of the nonregenerative braking system is denoted by M3.

At a later point in time brake pedal 9 is activated, which results in another braking request. In the present example, this braking request—although the braking capability of regenerative braking system 7 would actually be sufficient to cover it—is met only by the nonregenerative braking system. Of course, the braking request could also be met by regenerative braking system 7.

At this point it is noted that the braking capability of regenerative braking system 7 is of course not necessarily constant over time t. For example, the braking capability decreases when storage battery 6 is noticeably full, for example, for a fairly long descent. This would be manifested as a change in the progression of the dashed line. In addition, the braking capability of regenerative braking system 7 may be based on a deceleration of vehicle 1, a braking power, or a braking force. Instead of a curve of braking torque M, a curve of the deceleration of vehicle 1, the braking power, or the braking force could be illustrated in the diagram.

Although embodiments of the invention has been explained based on an electric vehicle and in this regard is also particularly advantageous, in principle a regenerative braking system which is optimized for energy efficiency may also be implemented in some other way. For example, a compressor or a turbine could supply/withdraw energy to/from a compressed air storage system. In addition, the energy recovered upon deceleration of vehicle 1 could be mechanically stored. Furthermore, the nonregenerative braking system does not necessarily have to be implemented using friction brakes. For example, alternatively or additionally, an eddy current brake, or a resistor which converts the excess electrical energy generated by electric motor 4 in generator mode into heat, may be provided. Thus, many implementation variants are conceivable for regenerative braking system 7 and the nonregenerative braking system, which due to the large number cannot be described here in detail, but which lie within the scope of the general knowledge of one skilled in the art.

In conclusion, it is noted that the illustrations in the figures are not all to scale. Furthermore, the individual variants illustrated in the figures may also constitute the subject matter of a separate invention.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for braking a vehicle having a regenerative braking system and a nonregenerative braking system, the method comprising:
detecting at least one of a position and a motion of an accelerator pedal;
determining whether the at least one of the detected position and the motion corresponds to one of a specifiable position and a specifiable motion which is associated with a deceleration request; and then
activating the regenerative braking system when the result of the determining step is positive,
wherein the nonregenerative braking system is additionally activated for a deceleration request which exceeds a braking capability of the regenerative braking system.

2. The method of claim 1, wherein the nonregenerative braking system is activated only enough to cover a portion of the deceleration request which exceeds the braking capability of the regenerative braking system.

3. The method of claim 2, wherein:
detecting the at least one of the position and the motion of the accelerator pedal further comprises detecting at least one of a position and a motion of a brake pedal, and
with regard to a division of the deceleration request between the regenerative braking system and the nonregenerative braking system, a deceleration request of the brake pedal is treated analogously to a deceleration request of the accelerator pedal.

4. The method of claim 2, wherein:
detecting the at least one of the position and the motion of the accelerator pedal further comprises detecting at least one of a position and a motion of a brake pedal, and
a maximum achievable deceleration using the brake pedal is greater than the maximum achievable deceleration using the accelerator pedal.

5. The method of claim 4, wherein at least one of the maximum achievable deceleration using the accelerator pedal and the maximum achievable deceleration using the brake pedal, is a function of the speed of the vehicle.

6. The method of claim 5, wherein a level of the deceleration request is a function of a speed with which one of the accelerator pedal and the brake pedal is moved.

7. The method of claim 6, wherein at least one of the maximum achievable deceleration using the accelerator pedal and the maximum achievable deceleration using the brake pedal, may be individually set.

8. The method of claim 7, wherein various dependencies of at least one of the maximum achievable deceleration using the accelerator pedal and the maximum achievable deceleration using the brake pedal, as a function of the speed of the vehicle is individually set.

9. The method of claim 2, wherein:
detecting the at least one of the position and the motion of the accelerator pedal further comprises detecting at least one of a position and a motion of a brake pedal, and
for a deceleration request of the brake pedal only the nonregenerative braking system is activated.

10. The method of claim 1, further comprising an energy storage system for the regenerative braking system, the energy storage system comprising an electric storage battery, wherein at least one of a state of charge and a temperature of the electric storage battery is used for determining the braking capability of the regenerative braking system.

11. The method of claim 5, wherein the maximum deceleration achieved using the accelerator pedal is at least 4 m/s².

12. The method of claim 11, wherein the braking capability of the regenerative braking system is at least one of optically and acoustically displayed.

13. The method of claim 12, wherein the activation of the nonregenerative braking system is at least one of optically and acoustically displayed.

14. A control/regulation system for a vehicle having a regenerative braking system and a nonregenerative braking system and an accelerator pedal, the control/regulation system comprising:
an input for detecting at least one of a position and a motion of the accelerator pedal;
means for determining whether the detected at least one position and motion corresponds to one of a specifiable position or a specifiable motion which is associated with a deceleration request;
an output for activating the regenerative braking system; and
an output for activating the nonregenerative braking system,
wherein the control/regulation system is set up to activate the nonregenerative braking system in addition to the regenerative braking system for the deceleration request which exceeds a braking capability of the regenerative braking system.

15. A vehicle comprising:
a regenerative braking system including a motor for driving the vehicle, a driving controller operatively connected to the motor, and a storage battery operatively connected to the driving controller;
a nonregenerative braking system including a brake;
an accelerator pedal;
a brake pedal;
a control/regulation system operatively connected to the accelerator pedal, the regenerative braking system and the nonregenerative braking system;
a sensor operatively connected to the control/regulation system for detecting at least one of the position and the motion of the accelerator pedal;
wherein:
the control/regulation system is configured to determine at least one of whether the detected position of the accelerator pedal corresponds to a specifiable position which is associated with a deceleration request of the vehicle and the detected motion of the accelerator pedal corresponds to a specifiable motion which is associated with a deceleration request of the vehicle;
the control/regulation system is configured to activate the regenerative braking system when the result of the determining the at least one of the detected position of the accelerator pedal and the detected motion of the accelerator pedal is positive, and
the control/regulation system is configured to activate the nonregenerative braking system when the deceleration request exceeds a braking capability of the regenerative braking system.

16. The vehicle of claim 15, wherein the control/regulation system is operatively connected to the driving controller and the storage battery.

17. The vehicle of claim 15, wherein the nonregenerative braking system is operatively connected to the accelerator pedal and the brake pedal.

18. The vehicle of claim 15, wherein the motor comprises at least a partial electric drive.

19. The vehicle of claim 15, wherein the storage battery comprises an electric storage battery which is provided as an energy storage system for the regenerative braking system.

20. The vehicle of claim 19, further comprising:
a first sensor for measuring the temperature of the storage battery; and
a second sensor for measuring the state of charge of the storage battery,
wherein the control/regulation system is operatively connected to the first sensor and the second sensor to ascertain the state of charge and the temperature of the storage battery and then determine a braking capability of the regenerative braking system based upon the sensed temperature and the state of charge.
